(19) United States
(12) Patent Application Publication
(10) Pub. No.: US 2023/0043040 A1
(43) Pub. Date: Feb. 9, 2023

(54) SYSTEM FOR CONTROLLING CLASSES OF AN E-BIKE

(71) Applicant: PETER COOPER, BETHLEHEM, PA (US)

(72) Inventor: PETER COOPER, BETHLEHEM, PA (US)

(21) Appl. No.: 17/881,944

(22) Filed: Aug. 5, 2022

Related U.S. Application Data
(60) Provisional application No. 63/230,501, filed on Aug. 6, 2021.

(51) Int. Cl. B62M 6/50; G06V 20/56; H04W 4/44; B62J 50/22; B62J 45/416

(52) U.S. Cl. CPC B62M 6/50; G06V 20/56; H04W 4/44; B62J 50/22; B62J 45/416; G06F 3/14

(57) ABSTRACT

Disclosed is a system for controlling Classes of an eBike. The eBike having a motor and a motor controller. The system includes a server, a dashboard and an input unit. The server stores Classes instructions to operate the eBike in one of the one or more Classes. The dashboard includes a memory unit for storing motor instructions, a processing unit for processing the stored motor instructions to operate the motor under the instructions from the server, a display unit for displaying the processed instructions and the Classes instructions, and a bi-directional communication unit to communicate with the server. The input unit wirelessly communicates with the server. The Classes instructions includes a Classes display module to display the one or more Classes and a Classes module for allowing a user to select one of the one or more Classes via the input unit. The processed motor instructions are communicated to the motor via the motor controller to ride the eBike in the selected Class.

### CROSS REFERENCE TO RELATED APPLICATION

This application claims priority from U.S. Provisional Application No. 63/230,501, filed on Aug. 6, 2021, titled ‘A SYSTEM FOR REMOTE CLASS CONTROL OF A E-BIKE’ the contents of each of which are incorporated herein by reference.

### BACKGROUND OF THE INVENTION

### 1. Field of the Invention

The present application generally relates to eBikes, and more particularly relates to a system for controlling Classes of an eBike.

### 2. Description of Related Art

Biking safety is a key concern for bike riders that use the roads with regular vehicle traffic. Hundreds of people are killed every year. According to the Federal Highway Administration (FHWA), from 2007 to 2019, 9,768 cyclists died across the U.S.A.

This is only getting worse. In the UK there was an increase of 40 percent in cycling related deaths in 2020 i.e.: 140 cyclists being killed, up from 100 in 2019 (Source: NHTSA).

The well-accepted belief is that there is a strong link between the speed of a bike and the severity and risk of injury to the rider and the public generally. EBikes have an electric motor giving the rider access to more power. It follows that eBikes will be used at higher speeds and therefore increase the risks. This is the theory, but it has yet to be proven.

There is no definitive study into eBike safety as it compares to bicycle safety, However, there are many opinions both ways. Some that say eBikes are more dangerous for elderly riders, or they encourage bad rider behaviour. There are also the counter opinions, that eBikes are safer as they offer more agility, the ability to accelerate more quickly away from traffic, out of trouble. Also, that the rider can keep power on while manoeuvring without having to coordinate pedaling and the necessary weight shifting and balancing requirements.

To reduce the risks to riders and the public, regulators in the USA have introduced legislation known as the “3-Class” System. It is currently implemented by more than 30 states in the USA, at the time of writing. This model legislation defines three common Classes of eBikes (based on speed, wattage, and operation), and allows states to decide which types of bicycle infrastructure each Class can use (typically Class 1 and Class 2 eBikes are allowed wherever traditional bikes are allowed). It also requires eBike makers to place a highly visible sticker on the frame to indicate an eBikes Class.

The three Classes are defined as follows:
Class 1: eBikes that are pedal-assist only, with no throttle, and have a maximum assisted speed of 20 mph.
Class 2: eBikes that also have a maximum speed of 20 mph, but are throttle-assisted.
Class 3: eBikes that are pedal-assist only, with no throttle, and a maximum assisted speed of 28 mph.

Currently eBikes are produced to fit one of these Classes only and this is difficult to change. A change in Class typically involves a return to the factory to have motor controller, motor or both swapped out. The problem therefore is that riders cannot easily have an eBike that is legal across geographical boundaries, different riding infrastructures, as regulations change or at the discretion of the user. Therefore, there is a need of a system to control/operate the Class of the eBike. Further, the system should be able to operate/control the Class of the eBike via an App or remotely via a web App or cloud computer.

### SUMMARY OF THE INVENTION

The following presents a simplified summary of the present disclosure in a simplified form as a prelude to the more detailed description that is presented herein. In accordance with teachings of the present invention, a system for controlling Classes of an eBike is provided.

An object of the present invention is to provide a system with a server for storing Classes instructions to operate the eBike in one of the one or more Classes, an input unit to wirelessly communicate with the server, and a dashboard attached to the eBike for communicating with the server.

The dashboard includes a memory unit for storing motor instructions, a processing unit for processing the stored motor instructions to operate the motor under the instructions from the server, a display unit coupled with the processing unit for displaying the processed instructions and the Classes instructions, and a bi-directional communication unit coupled to the processing unit to communicate with the server.

The Classes instructions include a Classes display module to display the one or more Classes on the display unit and a Classes module for allowing a user to select one of the one or more Classes via the input unit. The processed motor instructions are communicated to the motor via the motor controller to ride the eBike in the selected Class.

Another object of the present invention is to provide the input unit which is attached to the dashboard. The dashboard further includes a location unit to communicate location of the eBike to the server.

Another object of the present invention is to provide the Classes instructions with a location Class module to display Classes on the display unit based on the location of the eBike.

Another object of the present invention is to provide the system with a sensor to communicate sensed biometric parameters of a rider to the server. The sensor is a biometric sensor to allow an authenticated rider to start the eBike. Further, the server automatically selects a Class for the rider to ride the eBike based on the rider parameters sensed by the sensor.

These and other features, aspects, and advantages of the present invention will become better understood with reference to the following description and appended claims.

### BRIEF DESCRIPTION OF DRAWINGS

Illustrative embodiments of the present invention are described herein with reference to the accompanying drawings, in which like numerals throughout the figures identify substantially similar components, in which:

FIG. 1 illustrates a block diagram of a system for controlling Classes of an eBike;

FIG. 2 illustrates a block diagram of a dashboard;

FIG. 3 illustrates a block diagram of Classes instructions; and

FIG. 4 illustrates a schematic diagram of a display unit displaying Classes.

### DETAILED DESCRIPTION OF DRAWINGS

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

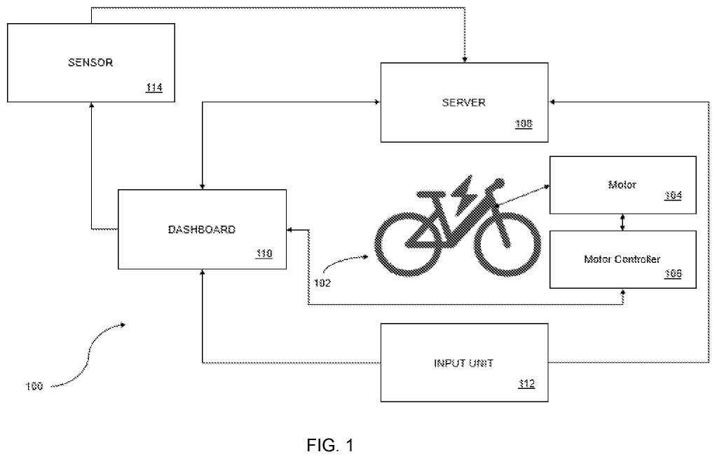

FIG. 1 illustrates a block diagram of a system 100 for controlling Classes of an eBike 102. The eBike is having a motor 104, and a motor controller 106. The system 100 includes a server 108, a dashboard 110 attached to the eBike 102 for communicating with the server 108, and an input unit 112 to wirelessly communicate with the server 108.

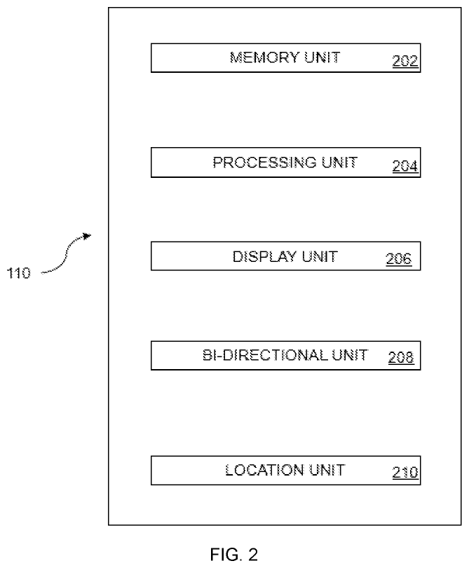

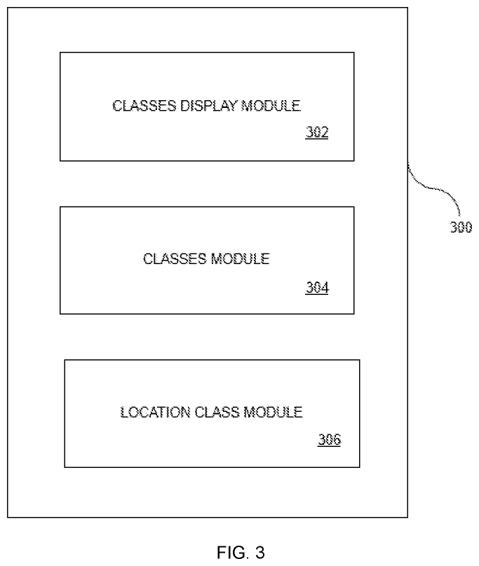

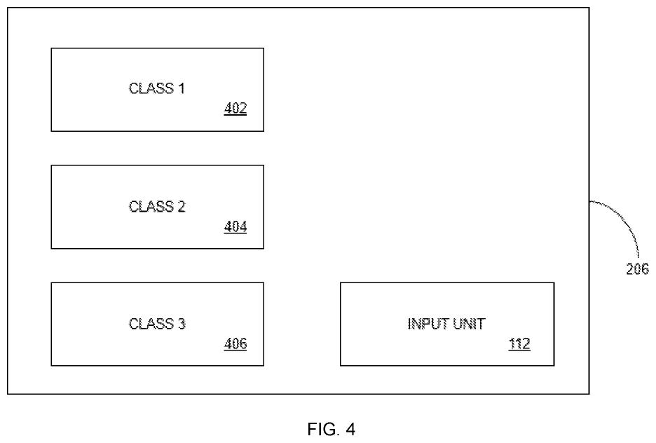

The server 108 stores Classes instructions to operate the eBike 102 in one of the one or more Classes. The Classes instructions are explained in detailed in conjunction with FIGS. 3 and 4 of the present invention. In other embodiments, the server 108 is a central server and may include a mobile application to display Classes instructions on the dashboard to operate the e-Bike. The dashboard 110 is explained in detail in conjunction with FIG. 2 of the present invention.

In other embodiments of the present invention, the system 100 further includes a sensor 114 to communicate biological parameters of a rider to the server 108. Examples of the sensor 114 include but not limited to camera, fingerprint sensors, biometric sensor, retina scan, etc. It would be readily apparent to those skilled in the art that the sensor 114 may be attached to a handlebar, a throttle, top tube, head tube, seat etc. without deviating from the scope of the present invention.

The sensor 114 are programmed to sense rider parameters like intoxication status, blood pressure, heart rate, if the rider is falling from the seat etc. The sensor 114 communicates the rider parameters to the server 108. Then, the server 108 controls and select the best Class to operate the eBike 102 based upon the rider parameters. Further, the server 108 allow only authenticated riders to start the eBike based on the sensed rider parameters.

Examples of the sensor 114 include but not limited to a biometric sensor such as fingerprint sensor, face recognition, voice recognition, iris recognition; and sensors like Electrocardiogram sensors, blood glucose sensors, blood oxygen sensors, pressure sensors, temperature sensors, heart rate sensors and cameras etc.

In an embodiment, the input unit 112 is a remote control unit to remotely/wirelessly select one Class from the available Classes to operate the eBike 102. In other embodiments, the input unit 112 is an interactive button attached to the dashboard 110 for allowing a user to select one Class from the available Classes to operate the eBike 102. It would be readily apparent to those skilled in the art that various input unit 112 may be envisioned without deviating from the scope of the present invention.

FIG. 2 illustrates a block diagram of the dashboard 110. The dashboard 110 is attached to the eBike 102. The dashboard 110 includes a memory unit 202, a processing unit 204, a display unit 206, and a bi-directional communication unit 208. The memory unit 202 stores motor instructions. The motor instructions operate the motor (104, shown in FIG. 1) via the motor controller (106, show in FIG. 1).

The processing unit 204 processes the stored motor instructions to operate the motor. The display unit 206 displays the processed instructions and Classes instructions. The bi-directional communication unit 208 communicates with the server (108, shown in FIG. 1).

The memory unit 202 may be implemented using any machine-readable or computer-readable media capable of storing data, including both volatile and non-volatile memory. Examples of the memory unit 202 may include but not limited to a read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information.

The processing unit 204 may be implemented using any processor or logic device, such as a complex instruction set computer (CISC) microprocessor, a reduced instruction set computing (RISC) microprocessor, a very long instruction word (VLIW) microprocessor, an x86 instruction set compatible processor, a processor implementing a combination of instruction sets, a multi-core processor such as a dual-core processor or dual-core mobile processor, or any other microprocessor or central processing unit (CPU).

The processing unit 204 may also be implemented as a dedicated processor, such as but not limited to a controller, a microcontroller, an embedded processor, a chip multiprocessor (CMP), a co-processor, a digital signal processor (DSP), a network processor, a media processor, an input/output (I/O) processor, a media access control (MAC) processor, a radio baseband processor, an application specific integrated circuit (ASIC), a field programmable gate array (FPGA), a programmable logic device (PLD), and so forth.

Examples of the bi-directional communication unit 208 may be operative to send and/or receive messages over one or more wireless networks, one or more wired connections, or a combination of both. Exemplary wireless networks include but are not limited to cellular radio access networks, wireless local area networks (WLANs), wireless personal area networks (WPANs), wireless metropolitan area network (WMANs), and satellite networks.

The display unit 206 may comprise any display device capable of displaying information received from the processing unit 204. Examples of the display unit 206 may include but not limited to a television, a monitor, a projector, and a computer screen, touch-interactive display screen (touchscreen), LCD, light emitting diode (LED) or other type of suitable visual interface.

In another embodiment of the present invention, the dashboard 110 further includes a location unit 210 for communicating location of the eBike with the server. Examples of the location unit 210 include but not limited to a GPS circuitry, GPS in combination with a cellular network, Wi-Fi location system, motion sensor, gyrometer etc.

The system (100, shown in FIG. 1) also determines what Class is allowed for various infrastructures. Examples of infrastructure are roads, highways, pedestrian sidewalks, bike paths, trails etc. The infrastructure also varies from state to state and within each local county. The infrastructure is sensed via cameras.

In an embodiment, the camera or cameras detect the infrastructure that the eBike is travelling on. The camera feeds a video data to the processing unit 204 to classify infrastructure information available to the eBike. Classification of infrastructure information results in providing information like potholes on the road, bypass, bike trail, highways, pedestrian sidewalk, accidents, road blocks, road conditions, etc. The processing unit 204 further includes a machine learning algorithm to learn and predict the infrastructure. The processing unit 204 communicates the infrastructure information to the server. Then, the server predicts the Classes based on the rider parameters, the location and the infrastructure.

FIG. 3 illustrates a block diagram for Classes instructions 300. The Classes instructions includes a Classes display module 302 to display the one or more Classes on the display unit (206, shown in FIG. 2), and a Classes module 304 for allowing a user to select one of the one or more Classes via the input unit (112, shown in FIG. 1).

The processed motor instructions are communicated to the motor (104, shown in FIG. 1) via the motor controller (106, shown in FIG. 1) to ride the eBike (102, shown in FIG. 1). The processing unit (204, shown in FIG. 2) processes the motor instructions under the instructions of the server (108, shown in FIG. 1).

FIG. 4 illustrates a schematic diagram of the display unit (206, shown in FIG. 2) displaying a Classes display module (304, shown in FIG. 3) in an exemplary embodiment. The display unit (206, shown in FIG. 2) displays the Classes display module (304, shown in FIG. 3) available three Classes such as ‘CLASS 1’ 402, ‘CLASS 2’ 404 & ‘CLASS 3’ 406.

Based upon the location of the eBike and may be also on the rider parameters, the server displays the available Classes on the display unit (206, shown in FIG. 2). The rider then selects the desired the Class to drive the eBike (102, shown in FIG. 1) using the input unit (112, shown in FIG. 1).

In another embodiment, though not shown in FIGURES, if the eBike is in a state (within USA) where only two Classes are permitted, then the server displays only the available Classes on the display unit. It would be readily apparent to those skilled in the art that the various number of Classes may be displayed based upon the location and/or rider parameters without deviating from the scope of the present invention.

The present invention offers various advantages such as providing a system that controls the Classes of the eBike through the server. The present invention further allows a fleet manager to manage the Classes of the eBike remotely through the server. Further, the present invention prevents any intoxicated rider to ride in a Class that may be dangerous at that time.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

The drawings and the forgoing description give examples of embodiments. Those skilled in the art will appreciate that one or more of the described elements may be very well combined into a single functional element. Alternatively, certain elements may be split into multiple functional elements. Elements from one embodiment may be added to another embodiment. For example, the orders of the processes described herein may be changed and are not limited to the manner described herein. Moreover, the actions of any flow diagram need not be implemented in the order shown; nor do all of the acts necessarily need to be performed.

Also, those acts that are not dependent on other acts may be performed in parallel with the other acts. The scope of embodiments is by no means limited by these specific examples. The components of the system including the devices and related technologies mentioned above are collectively used to improve performance of the eBike.

Numerous variations, whether explicitly given in the specification or not, such as differences in structure, dimension, and use of material, are possible. Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A system for controlling Classes of an eBike, wherein the eBike having a motor and a motor controller, the system comprising:
a server for storing Classes instructions to operate the eBike in one of the one or more Classes;
a dashboard attached to the eBike for communicating with the server, the dashboard comprising:
a memory unit for storing motor instructions;
a processing unit for processing the stored motor instructions to operate the motor under the instructions from the server;
a display unit coupled with the processing unit for displaying the processed instructions and the Classes instructions; and
a bi-directional communication unit coupled to the processing unit to communicate with the server;
an input unit to wirelessly communicate with the server;
wherein the Classes instructions comprising:
a Classes display module to display the one or more Classes on the display unit; and
a Classes module for allowing a user to select one of the one or more Classes via the input unit; wherein the processed motor instructions are communicated to the motor via the motor controller to ride the eBike in the selected Class.

2. The system according to claim 1 wherein the input unit is attached to the dashboard.

3. The system according to claim 1 wherein the dashboard further comprising a location unit to communicate location of the eBike to the server.

4. The system according to claim 3 wherein the Classes instructions further comprising a location Class module to display Classes on the display unit based on the location of the eBike.

5. The system according to claim 1 further comprising a sensor to communicate sensed biometric parameters of a rider to the server.

6. The system according to claim 5 wherein the sensor is a biometric sensor to allow an authenticated rider to start the eBike.

7. The system according to claim 6 wherein the biometric sensor detects and communicates the biological parameters of the rider to the server.

8. The system according to claim 1, wherein the user is a rider.

9. The system according to claim 1, wherein the user is a manager, wherein the manager is managing the eBike remotely via the server.

10. The system according to claim 1, wherein the sensor is a camera, wherein the camera feeds a video data to the processing unit to classify infrastructure information available to the eBike.

11. The system according to claim 10, wherein the infrastructure information is communicated to the server by the processing unit via the bi-directional communication unit; wherein the server selects a Class to drive the eBike based on the infrastructure.

12. The system according to claim 11 wherein the processing unit comprising of a machine learning algorithm to learn and predict infrastructure information, and then communicated the infrastructure information to the server.
